(19) United States
(12) Patent Application Publication
(10) Pub. No.: US 2009/0138555 A1
(43) Pub. Date: May 28, 2009

(54) Method and apparatus for maintaining connectivity in a network

(75) Inventors: Michail Bletsas, Wellesley, MA (US); Nicholas Negroponte, Cambridge, MA (US)

Correspondence Address: William L , Botjer, PO Box 478, Center Moriches, NY, 11934, US

(73) Assignee: One Laptop per Child Association Inc.

(21) Appl. No.: 12/315,042

(22) Filed: Nov. 26, 2008

Related U.S. Application Data
(60) Provisional application No. 61/004,287, filed on Nov. 26, 2007.

(51) Int. Cl. G06F 15/16

(52) U.S. Cl. 709/204

(57) ABSTRACT

A method and system for maintaining connectivity in a network. The network includes a plurality of computational devices. A first computational device includes a main processor and a co-processor. The first computational device receives the at least one data frame from a second computational device and forwards the at least one data frame to a third computational device by using the co-processor without intervention from the main processor by using network protocols corresponding to layer-2 and layer-1 of Open System Interconnection (OSI) reference model.

### REFERENCE TO RELATED APPLICATIONS

This application claims priority of U.S. provisional application Ser. No. 61/004,287 filed Nov. 26, 2007.

### FIELD OF THE INVENTION

The invention relates in general to the field of networks. More specifically, the invention relates to maintaining connectivity in a network.

### BACKGROUND

A network is a group of interconnected computational devices enabled to share information with each other. Examples of the computational device include, but are not limited to, computers, laptops, Personal Digital Assistants (PDAs), mobile phones, and handheld and pocket devices etc. The network enables the computational devices to share information such as hardware resources, programs, data files and services. Examples of the network include, but are not limited to, wireless network, wired network, telecommunication network, Local Area Network (LAN), Wide Area Network (WAN) etc.

The architecture of the network is arranged as a seven layered model corresponding to Open Systems Interconnection (OSI) reference model. Each layer of the OSI reference model performs certain pre-defined functions, by using protocols provided at that layer, to support the layer above it and receives services from the layer below it. Layer-1 of the OSI reference model is referred to as physical layer and defines all the electrical and physical specifications required for sending a bit stream in the network to enable communication between computational devices in the network. Layer-2 is referred to as data link layer and provides functional and procedural means to transfer data between computational devices. Further, the data link layer arranges the bit stream it receives from the physical layer into logical chunks of data, which are known as data frames. Layer-3 is referred to as network layer and provides functional and procedural means for transferring variable length data sequences from a source to a destination via one or more networks. The network layer is also responsible for initiating, maintaining and terminating connections between the computational devices in the network. Further, the network layer performs network routing functions. Typically, routers also operate on the network layer in order to select a path in the network along which the data frames are forwarded. The data at the network layer level is split into packets, with each packet being composed of multiple data frames. The splitting is done to adjust size of data to maintain compatibility with the protocol being used at the layer-2. Layer-4 is referred to as the transport layer and provides transfer of data between end computational devices. Layer-5 referred to the as session layer allows applications running on computational devices to initialize, maintain and terminate sessions through the network. Layer-6 is referred to as the presentation layer which manages data encoding. Layer-7 is referred to as the application layer and provides an interface for the user operating a computational device connected to a network.

As described earlier, the network can be a wireless network. The wireless network facilitates and simplifies the process of adding new computational devices to the network. Further, reconfiguring the connections of the computational devices in the network is also convenient. The computational devices exchange and share data with each other in the form of data frames. A data frame is a block of data forwarded over a network and contains all the necessary information required to move the data from its source to its destination. In the network, the data frames can be forwarded from a source computational device to a destination computational device either directly or through one or more intermediate computational devices which provide a path for forwarding data frames from the source computational device to the destination computational device. Typically, in existing wireless networks, the process of forwarding the data frames from the source computational device to the destination computational device requires intervention of the main processor of intermediate computational devices through which the data frames are forwarded. The main processor needs to be powered on for the process of data frame forwarding and to maintain the connection to the network, regardless of whether processing by the intermediate computational device is required or not. However, if any of the intermediate computational devices is operating in power saving mode i.e., the main processor of the intermediate computational device is not operating, the network gets disconnected and the data frames can be lost. As a result, the source computational device is not able to communicate continuously with the destination computational device in the network. Further, the main processor consumes a substantial amount of power to operate and maintain the connection to the network. Thus, in case of a mobile computational device such as a laptop, the battery backup is shortened if the laptop needs to be connected to the network continuously. Further, if many such intermediate computational devices are present between the source computational device and the destination computational device, then collectively a lot of power is consumed in merely keeping the main processors of all the intermediate computational devices active in order to simply transfer data frames which results in wastage of power.

Presently, in the case of cell phones, the data frame forwarding operations are offloaded from the main processor to peripheral processors to conserve power in the cell phone. For example cell phone Wi-Fi radios offload TCP/IP networking stack processing to the peripheral processor that drives the radio. However, even after offloading the forwarding operations to a peripheral processor, intervention from the main processor is still required to forward data frames to the other cell phones in its vicinity. As a result, the main processor needs to be powered on to maintain the connection to the network.

In light of the above, there is a need for a method and apparatus that facilitates the process of maintaining connectivity in a network even when the main processor of the intermediate computational devices is not operating. At the same time, the method and the apparatus should be able to provide connectivity in the network while keeping low power consumption.

### SUMMARY

An object of the present invention is to provide a method and system for maintaining connectivity in a network.

Another object of the present invention is to provide a method and system for reducing the power required by a computational device to maintain connectivity in the network.

Yet another object of the invention is to maintain connectivity in the network even when the main processor of the computational device is not operating.

To achieve the foregoing objects, and in accordance with the purpose of the invention as broadly described herein, the present invention provides a method for maintaining connectivity in a network. The network comprises a plurality of computational devices. A first computational device in the network, which comprises a main processor and a co-processor, forwards at least one data frame from a second computational device to a third computational device. The first computational device receives the at least one data frame from the second computational device, processes the at least one data frame by using the co-processor without any intervention from the main processor and forwards the at least one data frame to the third computational device by using the co-processor.

To achieve the foregoing objects, and in accordance with the purpose of the invention as broadly described herein, the present invention provides a system for maintaining connectivity in a network. The network comprises plurality of computational devices. A first computational device in the network forwards at least one data frame from a second computational device to a third computational device. The first computational device comprises a main processor and a co-processor. The main processor processes information corresponding to layer-3, layer-4, layer-5, layer-6 and layer-7 of Open System Interconnection (OSI) reference model. The co-processor processes information corresponding to layer-2 and layer-1 of the OSI reference model.

### BRIEF DESCRIPTION OF THE DRAWINGS

Various embodiments of the present invention will hereinafter be described in conjunction with the appended drawings provided to illustrate and not to limit the invention, wherein like designations denote like elements, and in which:

FIG. 1 is an exemplary network where various embodiments of the present invention can be practiced;

FIG. 2 is a block diagram of a computational device, in accordance with an embodiment of the present invention; and

FIG. 3 is a flowchart illustrating a method for maintaining connectivity in a network, in accordance with an embodiment of the present invention.

### DESCRIPTION OF VARIOUS EMBODIMENTS

Various embodiments of the present invention provide a method and system for maintaining connectivity in a network. The network includes a plurality of computational devices, which exchange data in form of data frames with each other. A first computational device of the plurality of computational devices forwards at least one data frame from a second computational device of the plurality of computational devices to a third computational device of the plurality of computational devices. The first computational device includes a main processor and a co-processor. The first computational device receives the at least one data frame from the second computational device and forwards the at least one data frame to the third computational device by using the co-processor without intervention from the main processor. The co-processor forwards the at least one data frame to the third computational device by using network protocols corresponding to layer-2 and layer-1 of Open System Interconnection (OSI) reference model.

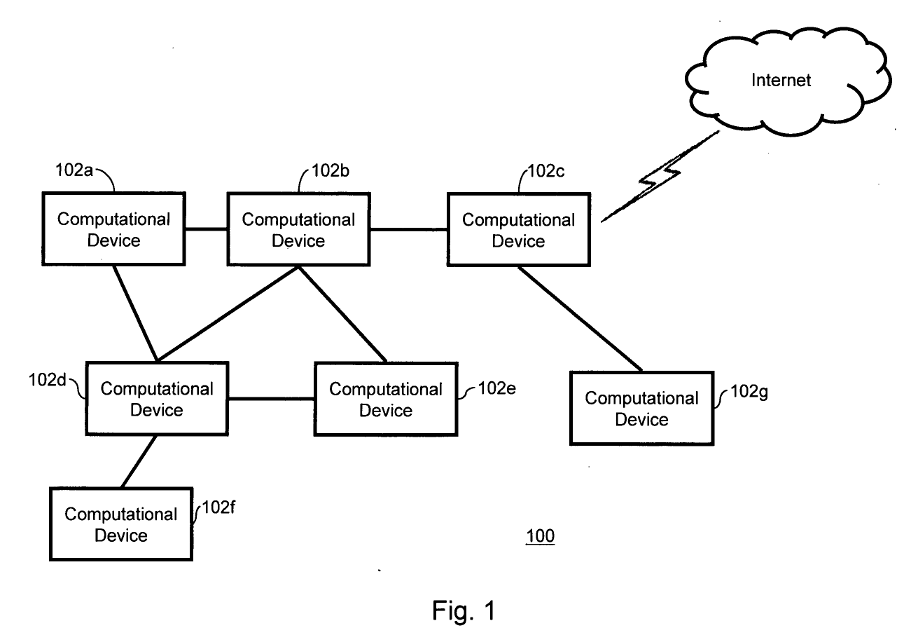

FIG. 1 illustrates an exemplary network 100 where various embodiments of the present invention can be practiced. Network 100 can be a Local Area Network (LAN), Wide Area Network (WAN) or other types of networks which could be wired or wireless. Network 100 includes a plurality of computational devices 102a-g. Examples of the plurality of computational devices can include, but are not limited to, personal computers, laptops, Personal Digital Assistants (PDAs), mobile phones, and handheld and pocket devices.

Network 100 can be configured into various modes such as a peer-to-peer network, a client-server network, a mobile ad hoc network and so forth. Further, network 100 can be connected according to various network topologies. Examples of network topologies include, but are not limited to, a bus topology, a star topology, a ring topology, a mesh topology, a tree topology and the like. In accordance with an embodiment of the present invention the computational devices 102a-g are connected in a partial-mesh topology. In accordance with an embodiment of the present invention, the architecture of network 100 is arranged as a seven layered model corresponding to Open System interconnection (OSI) reference model.

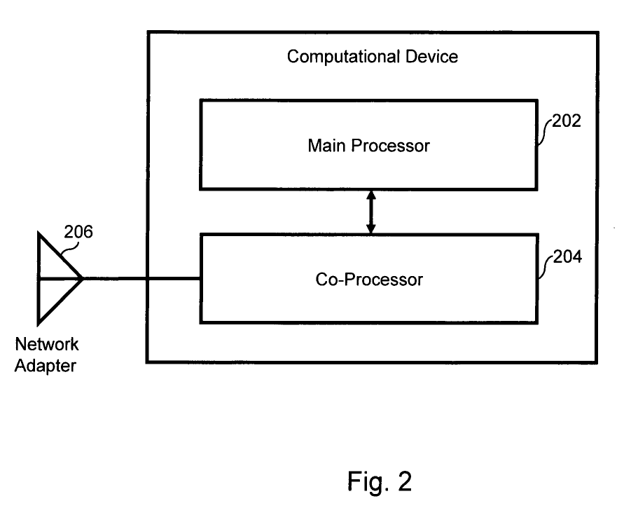

Network 100 enables computational devices 102a-g to communicate among themselves and to share and exchange information, files and data. Computational devices 102a-g share information by exchanging data frames. A data frame is a block of data forwarded over a network and contains all the necessary information required to move the data from its source to its destination. Hereinafter, the exchange of data frames is interchangeably referred to as data frame forwarding. The process of data frame forwarding enables computational devices 102a-g to maintain connectivity in network 100. Computational devices 102a-g forward data frames by using network protocols corresponding to various layers of the OSI reference model. The data frames forwarded by a computational device include the data frames created by the computational device and the data frames received by the computational device from another computational device in the network. The data frames received by the computational device from another computational device in the network can be modified by the computational device prior to forwarding. In accordance with an embodiment of the present invention, source computational device 102a communicates with destination computational devices 102b, 102d and 102e by directly forwarding the data frames to each of them. In accordance with another embodiment of the present invention, source computational device 102a communicates with destination computational device 102g by forwarding the data frames to destination computational device 102g through one or more intermediate computational devices. For instance, source computational device 102a forwards the data frames to intermediate computational device 102c which further forwards the data frames to destination computational device 102g. As a result, intermediate computational device 102c aids in maintaining connectivity in network 100. The forwarding of the data frames by intermediate computational device 102c has been described in detail in conjunction with FIG. 2.

FIG. 2 illustrates a block diagram of computational device 102c, in accordance with an embodiment of the present invention. To describe the invention, reference will be made to network 100 illustrated in conjunction with FIG. 1, although it will be apparent to those skilled in the art that computational device 102c can function with any other network. Computational device 102c includes a main processor 202, a co-processor 204 and a network adapter 206. Main processor 202 and co-processor 204 include logical circuits that drive computational device 102c. These logical circuits respond to and process the basic instructions that guide the functioning of computational device 102c. In accordance with an embodiment of the present invention, computational device 102c may also have additional circuitry required for efficient processing along with main processor 202, co-processor 204 and network adapter 206. In accordance with an embodiment of the present invention, co-processor 204 is connected to main processor 202 by a high-speed bus connection. In accordance with another embodiment of the present invention, co-processor 204 is connected to main processor 202 by means other than the high-speed bus connection. Further, in some cases, power required by co-processor 204 to operate is less than the power required by main processor 202 to operate.

As illustrated in FIG. 1, first computational device 102c (intermediate computational device) facilitates communication and maintains connectivity between second computational device 102a (source computational device) and third computational device 102g (destination computational device). Further, the information is exchanged between these computational devices in form of the data frames.

Processing of the data frames corresponding to various layers of the OSI reference model is divided between main processor 202 and co-processor 204. Main processor 202 processes information corresponding to layer-3, layer-4, layer-5, layer-6 and layer-7 of the OSI reference model. Co-processor 204 can process information corresponding to layer-2 and layer-1 of the OSI reference model. Main processor 202 can process layer-3 information by using layer-3 network protocols. Examples of the layer-3 network protocols include, but are not limited to, Border Gateway Protocol (BGP), Internet Protocol version 4 (IPv4), Internet Protocol version 6 (IPv6) and the like. Co-processor 204 can process layer-2 information by using layer-2 network protocols. Examples of layer-2 network protocols include, but are not limited to, TCP/IP's Serial Link Interface Protocol (SLIP) and Point-to-Point Protocol (PPP). The processing of co-processor 204 is free of intervention from main processor 202, i.e. co-processor 204 can operate even when main processor 202 is not operating.

Co-processor 204 includes firmware through which first computational device 102c implements a layer-2 mesh network with the other computational devices in network 100. In accordance with an embodiment of the present invention, the layer-2 mesh network is based on the IEEE 802.11s standard. In accordance with an embodiment of the present invention, first computational device 102c forwards at least one data frame from second computational device 102a to third computational device 102g in network 100 by using co-processor 204. In accordance with another embodiment of the present invention, first computational device 102c modifies the at least one data frame prior to forwarding the at least one data frames to third computational device 102g by using main processor 202 and forwards the at least one data frame to third computational device 102g by using co-processor 204. As described earlier, co-processor 204 can forward the at least one data frame while remaining free of intervention from main processor 202. This means, first computational device 102c can forward the at least one data frame even when main processor 202 is not operating and thus maintains connectivity in network 100.

In accordance with an embodiment of the present invention, when first computational device 102c is connected to the Internet, first computational device 102c can act as a mesh portal. Other computational devices connected with first computational device 102c in network 100 i.e. computational devices 102a-g can connect to the Internet through first computational device 102c acting as the mesh portal. While providing connectivity to the Internet, first computational device 102c can forward the at least one data frame between other computational devices in network 100 and the Internet by using co-processor 204. Therefore, first computational device 102c does not require main processor 202 to operate to provide mesh portal to other computational devices in network 100.

Since in a real scenario, in network 100 there are more than one intermediate computational device, the ability to forward the at least one data frame by using the co-processor, being free from intervention of the main processor, will save a lot of power that otherwise would have been required to keep the main processors of all the intermediate computational devices operating.

Network adapter 206 is a device that enables first computational device 102c to communicate in network 100. In accordance with an embodiment of the present invention, network adapter 206 can be a wireless network adapter. In accordance with another embodiment of the present invention, network adapter 206 can be a wired network adapter. Further, network adapter 206 is coupled to co-processor 204 by a high-speed bus connection. In accordance with another embodiment of the present invention, network adapter 206 is coupled to co-processor 204 by means other than the high-speed bus connection.

Network adapter 206 receives the at least one data frame from second computational device 102a in network 100. Network adapter 206 forwards the at least one data frame received from second computational device 102a to co-processor 204 for processing information corresponding to layer-2 and layer-1 of the OSI reference model. In accordance with an embodiment of the present invention, network adapter 206 forwards the at least one data frames from co-processor 204 to third computational device 102g in network 100. The process of data frame forwarding from co-processor 204 is free from intervention from main processor 202 and is possible even when main processor 202 is not operating.

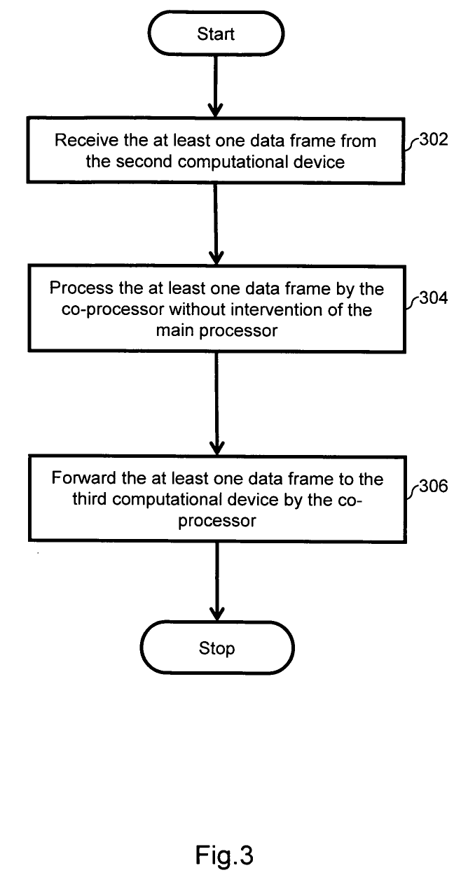

In accordance with another embodiment of the present invention, when first computational device 102c modifies the at least one data frame prior to forwarding the data frames to third computational device 102g, the at least one data frame is forwarded to main processor 202 for processing information corresponding to layer-3, layer-4, layer-5, layer-6 and layer-7 of the OSI reference model. Co-processor 204 processes information corresponding to layer-2 and layer-1 of the OSI reference model. Further, network adapter 206 forwards the at least one data frame from co-processor 204 to third computational device 102g in network 100 in accordance with another embodiment of the present invention. Thus, intervention from main processor 202 is only required when the at least one data frame is modified by first computational device 102c prior to forwarding. The method for forwarding the at least one data frame to maintain connectivity in the network is explained in detail in conjunction with FIG. 3.

FIG. 3 is a flowchart illustrating a method for maintaining connectivity in a network, in accordance with an embodiment of the present invention. To describe the method, reference will be made to FIGS. 1 and 2, although it will be apparent to those skilled in the art that the method can be applicable to any other suitable embodiment of the present invention. Network 100 includes a plurality of computational devices 102a-g. As described earlier, first computational device 102c forwards the at least one data frame from second computational device 102a to third computational device 102g. First computational device 102c includes main processor 202 and co-processor 204.

At step 302, first computational device 102c receives the at least one data frame from second computational device 102a. In accordance with an embodiment of the present invention, first computational device 102c can receive the at least one data frame through network adapter 206. On receiving the at least one data frame from second computational device 102a, co-processor 204 processes the at least one data frame for information corresponding to layer-2 and layer-1 of the OSI reference model without intervention from main processor 202, at step 304. At step 306, the at least one data frame is forwarded to third computational device 102g by co-processor 204 of first computational device 102c. In accordance with an embodiment of the present invention, first computational device 102c can forward the at least one data frame to third computational device 102g through network adapter 206. Co-processor 204 forwards the at least one data frame to third computational device 102g by using network protocols corresponding to layer-2 and layer-1 of the OSI reference model.

In accordance with another embodiment of the present invention, first computational device 102c modifies the at least one data frame prior to forwarding the at least one data frames to third computational device 102g by using main processor 202. Main processor 202 processes information corresponding to layer-3, layer-4, layer-5, layer-6 and layer-7 of the OSI reference model. Further first computational device 102c forwards the at least one data frame to third computational device 102g by co-processor 204. In accordance with another embodiment of the present invention, first computational device 102c can forward the at least one data frame to third computational device 102g through network adapter 206. Co-processor 204 forwards the at least one data frame to third computational device 102g by using network protocols corresponding to layer-2 and layer-1 of the OSI reference model.

The method and system facilitates the process of maintaining connectivity in the network, even when the main processor of the intermediate computational device is not operating. Further, the method reduces the power consumption of the intermediate computational device, while maintaining connectivity with the network. Since in a real scenario, in the network there are more than one intermediate computational device, the ability to forward the at least one data frame by using the co-processor, being free from intervention of the main processor, will save considerable power that otherwise would have been required to keep the main processors of all the intermediate computational devices operating. Furthermore, the use of the network protocols corresponding to layers-2 and layer-3 of the OSI reference model enables to use a variety of layer-3 network protocols without modifying the firmware of the co-processor.

While the preferred embodiments of the present invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method of maintaining connectivity in a network, the network comprising a plurality of computational devices, wherein a first computational device of the plurality of computational devices forwards at least one data frame from a second computational device of the plurality of computational devices to a third computational device of the plurality of computational devices, the first computational device comprising a main processor and a co-processor, the method at the first computational device comprising:
(a) receiving the at least one data frame from the second computational device;
(b) processing the at least one data frame by the co-processor, wherein the processing is free of intervention of the main processor; and
(c) forwarding the at least one data frame to the third computational device by the co-processor.

2. The method according to the claim 1, wherein the co-processor processes information corresponding to layer-2 and layer-1 of Open System Interconnection (OSI) reference model.

3. The method according to the claim 2, wherein the main processor processes information corresponding to layer-3, layer-4, layer-5, layer-6 and layer-7 of the OSI reference model.

4. The method according to the claim 2, wherein the co-processor forwards the at least one data frame to the third computational device by using network protocols corresponding to the layer-2 and layer-1 of the OSI reference model.

5. Apparatus for maintaining connectivity in a network of plurality of computational devices including at least a first, a second and a third computational devices, the first computational device of the plurality of computational devices forwarding at least one data frame from the second computational device of the plurality of computational devices to the third computational device of the plurality of computational devices, the first computational device comprising:
(a) a main processor configured to process information corresponding to layer-3, layer-4, layer-5, layer-6 and layer-7 of Open System Interconnection (OSI) reference model; and
(b) a co-processor configured to process information corresponding to layer-2 and layer-1 of the OSI reference model.

6. The apparatus according to claim 5, wherein the co-processor of the first computational device is further configured to forward the at least one data frame to the third computational device by using network protocols corresponding to the layer-2 and layer-1 of the OSI reference model.

7. The apparatus according to claim 5, wherein the first computational device further comprises a network adapter configured to:
(a) receive the at least one data frame from the second computational device;
(b) forward the at least one data frame to the co-processor; and
(c) forward the at least one data frame from the co-processor to the third computational device.

8. The apparatus according to claim 5, wherein the power required by the co-processor of the first computational device to operate is less than the power required by the main processor to operate.

9. The apparatus according to claim 5 wherein the first computational device is configured to form a layer-2 mesh network with at least one of the second computational device and the third computational device by using the co-processor.
